(19) United States
(12) Patent Application Publication
(10) Pub. No.: US 2006/0059431 A1
(43) Pub. Date: Mar. 16, 2006

(54) Real-time collaborative graphics application and method for use on a computer network having a collaborative networking platform

(75) Inventor: Michel Pahud, Redmond, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 10/930,067

(22) Filed: Aug. 30, 2004

(51) Int. Cl. G06F 17/00

(52) U.S. Cl. 715/751

(57) ABSTRACT

A real-time collaborative graphics application and method (such as Microsoft® Visio®) that runs on top of a collaborative networking platform (such as Microsoft® ConferenceXP) and provides real-time collaboration. The real-time collaborative graphics application and method personalizes local objects created by a local to readily distinguish them from remote objects created by remote users. Identifiers are used to allow the authorship of an object to be easily determined by all users. Local objects, remote objects, and a combination of the two can be moved and manipulated by any users. A local user may avoid sharing his local objects with remote users. Moreover, a local user can decide to hide remote objects created by remote users. If at a later time the local user decides to once again view the hidden remote objects, all updates since the remote shapes were hidden are automatically updated at the local user's document.

### TECHNICAL FIELD

The present invention relates in general to computer network applications and more particularly to a collaborative graphics application and method (such as Microsoft® Visio®) that runs on top of a collaborative networking platform (such as Microsoft® ConferenceXP) and provides real-time collaboration.

### BACKGROUND OF THE INVENTION

Collaborative computing is becoming increasingly important in learning environments as well as in business environments. Collaborative computing allows two or more users located in different physical locations to be able to work together on a project or task in a computer network setting. By way of example, suppose that one user in Miami has a flow diagram that he would like to show a user in Seattle. Using the collaborative computing, the Miami user would like to have the Seattle user comment on the flow diagram and mark it up if necessary. In this manner, the two users can collaborate on the flow diagram.

Collaborative computing uses a collaborative networking platform to support collaborative applications. One example of a collaborative networking platform is the ConferenceXP research platform by Microsoft® Corporation of Redmond, Wash. ConferenceXP supports the development of real-time collaboration and videoconferencing applications. In other words, the collaborative networking platform supports a collaborative application running on top of the platform. An application is a program or group of programs usually designed for end users. Applications include database programs, word processing programs, spreadsheet programs, and graphical programs. Figuratively speaking, an application sits on top of a platform (or operating system) because it is unable to run without the operating system and system utilities. It should be noted that applications that sit on top of ConferenceXP are also called “Capabilities”.

ConferenceXP uses a peer-to-peer architecture, instead of a server-client architecture. This peer-to-peer architecture of ConferenceXP alleviates network traffic bottlenecks and single points of failure and simplifies deployment. Typically, ConferenceXP uses multicast to provide efficiency and scalability, although unicast may also be used where multicast is unavailable. In this situation, a participant in unicast is able to join a multicast session.

Current applications are not specifically designed to run on top of a collaborative networking platform, such as ConferenceXP. Instead, current applications use application sharing. Application sharing is a network conferencing feature that enables conference participants (such as the Miami user and the Seattle user) to simultaneously see the same application on their respective computer monitors. In this manner, the Miami user could start a graphics application on his computer and share the flow diagram with the Seattle user.

One problem, however, with application sharing is that it has limited capabilities. In particular, application sharing does not allow real-time collaboration between users. Application sharing means that each user must do the same thing with a limited amount collaboration. Each user sees the same aspects of the shared application, without any way to distinguish between each user's contribution to the shared application. They cannot see different aspects of the same application. Other features that are lacking with application sharing includes hiding local objects created by a local user, hiding remote objects created by remote users, applying constraints to the objects created by remote and local users, and grouping the users into sub-groups.

In addition to the aforementioned features that are lacking, application sharing also lacks real-time processing capability. This is because application sharing fails to take advantage of a collaborative networking platform, such as ConferenceXP. Thus, shared application typically is run on a computer network having a client/server architecture. This type of architecture limits the efficacy of real-time processing because of the fact that there are server delays.

One popular type of graphics application is Visio® by Microsoft® Corporation. Visio® can by used to design a variety of diagrams (electrical diagrams, floor plan, business process, program architecture, state machines, and for forth), but has heretofore lacked any collaboration capability. That is, Visio® has previously not provided for collaboration in which every user can have his own view of the diagram and hide sub-diagrams created by other collaborators.

Therefore, what is needed is a collaborative graphics application and method (such as Visio®) that runs on top of a collaborative networking platform (such as ConferenceXP) such that the application allows real-time processing and provides a rich variety of collaborative features. These needed collaborative features include distinguishing between local objects created by a local user and remote objects created by remote users, hiding of both local and remote objects, selection of local and remote objects such that they can be moved together, using a constraints solver, and grouping of network users into sub-groups.

### SUMMARY OF THE INVENTION

The invention disclosed herein includes a real-time collaborative graphics application and method designed to run on top of a collaborative networking platform to take full advantage of a rich variety of collaborative features. The real-time collaborative graphics application and method allows user of a computer network running a collaborative networking platform to allow users to collaboratively create diagrams with a graphics application (such as Visio®) in real time.

Collaborative diagram creation is quite useful in today's business and educational environments. Many different fields use diagram creation, such as, for example, electrical diagrams, floor plans, business processes, program architecture, and user interface design. The real-time collaborative graphics application and method allows effective real-time collaboration from separate physical locations without the need for travel.

The real-time collaborative graphics application and method disclosed herein allows a local user to personalize local objects created by him, such that the local objects can be readily distinguished from remote objects created by remote users. This is achieved by using an identifier for each author of an object. The identifier includes color, shape, text and line thickness of the object. These identifiers allow the authorship of an object to be easily determined by all users.

The real-time collaborative graphics application and method also allows a local user to avoid sharing his local objects with remote users. In this manner, the local user can decide that he is the only one that will view local objects created by him. Moreover, a local user can decide to hide remote objects created by remote users. If at a later time the local user decides to once again view the hidden remote objects, all updates since the remote shapes were hidden are automatically updated at the local user's document.

Local objects, remote objects, and a combination of the two can be moved and manipulated by any users using the real-time collaborative graphics application and method. Manipulation includes the moving, rotation, deletion and resizing of both local and remote objects. The manipulation of the objects is seen by both the local user and remote users, unless of course a user has remote objects hidden. This movement and manipulation can be shown in one of two ways. First, the movement and manipulation can be shown in real time, such that as a local user move and manipulates an object the movement and manipulation is displayed in real time for the remote users. Alternatively, the movement and manipulation can be shown after the local user has released a button of an input device (such as a mouse button). This approach shows the end product of the movement and manipulation of the object.

The real-time collaborative graphics application and method runs on top of a collaborative networking platform (such as ConferenceXP). This allows the real-time collaborative graphics application and method to take advantage of the real time capability and facilitates real-time collaboration. In addition, the platform can run several applications simultaneously. This allows the real-time collaborative graphics application and method to utilize discussion threads (including video, video conferencing, photographs and text) to aid in the real-time collaboration. In addition, the discussion thread can include a voting thread that allows a user to ask for the votes of other users as to how a particular object should be manipulated.

With ConferenceXP as the platform, all of the aforementioned behaviors can easily be changed or improved. In fact, the ConferenceXP application programming interface (API) is very easy to use, which simplifies improvement of the real-time collaborative graphics application. In addition, ConferenceXP is created on the Microsoft®.NET Framework so it benefits from the rich libraries and could be done with any .NET languages (the current version has been created in C# language).

### BRIEF DESCRIPTION OF THE DRAWINGS

The present invention can be further understood by reference to the following description and attached drawings that illustrate aspects of the invention. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 is a block diagram illustrating an exemplary implementation of the real-time collaborative graphics application system, including the real-time collaborative graphics application and method disclosed herein.

FIG. 2 is a detailed block diagram illustrating details of the real-time collaborative graphics application and method disclosed herein.

FIG. 3 illustrates an example of a suitable computing system environment in which the real-time collaborative graphics application and method shown in FIGS. 1 and 2 may be implemented.

FIG. 4 is a general flow diagram illustrating the general operation of the real-time collaborative graphics application system shown in FIG. 1.

FIG. 5 illustrates an initialization process of a working example whereby a venue is joined.

FIG. 6 illustrates what the local user sees after a venue is selected.

FIG. 7 illustrates a user selecting to start the Collaborative Visio application.

FIG. 8 illustrates a user interface that a local user might see after launching the application.

FIG. 9 illustrates the application window as the local user selects a color for his objects.

FIG. 10 illustrates a user dragging and dropping a object onto the document.

FIG. 11 illustrates what a local user sees when a remote user adds a object.

FIG. 12 illustrates the local user adding another object to the local document.

FIG. 13 illustrates the local user selected a combination of local and remote objects.

FIG. 14 illustrates the local user moving the combination of remote object and the second local object from the location shown in FIG. 13 to another location within the local document.

FIG. 15 illustrates how a local user can choose to hide remote objects, to not share local objects, or both.

FIG. 16 illustrates the local use choosing to view the hidden remote objects.

FIG. 17 illustrates from a remote user's perspective the updated changes shown in FIG. 16.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Many current tools allow sharing of applications. However, these tools are merely performing application sharing, but not real-time collaboration. In fact, none of these tools allow real collaboration whereby each user can have his own view of a diagram, hide sub-diagrams created by himself and other collaborators, and use constraints and sub-grouping. The real-time collaborative graphics application and method disclosed herein allows collaborative diagram creation with the possibility to personalize and identify every object or shape (such as using color), manipulate local objects and remote objects or a mixed set of local and remote objects. The application and method also can use constraints and have collaboration on a large diagram where sub-groups of people are working on separate parts of the diagram.

II. General Overview

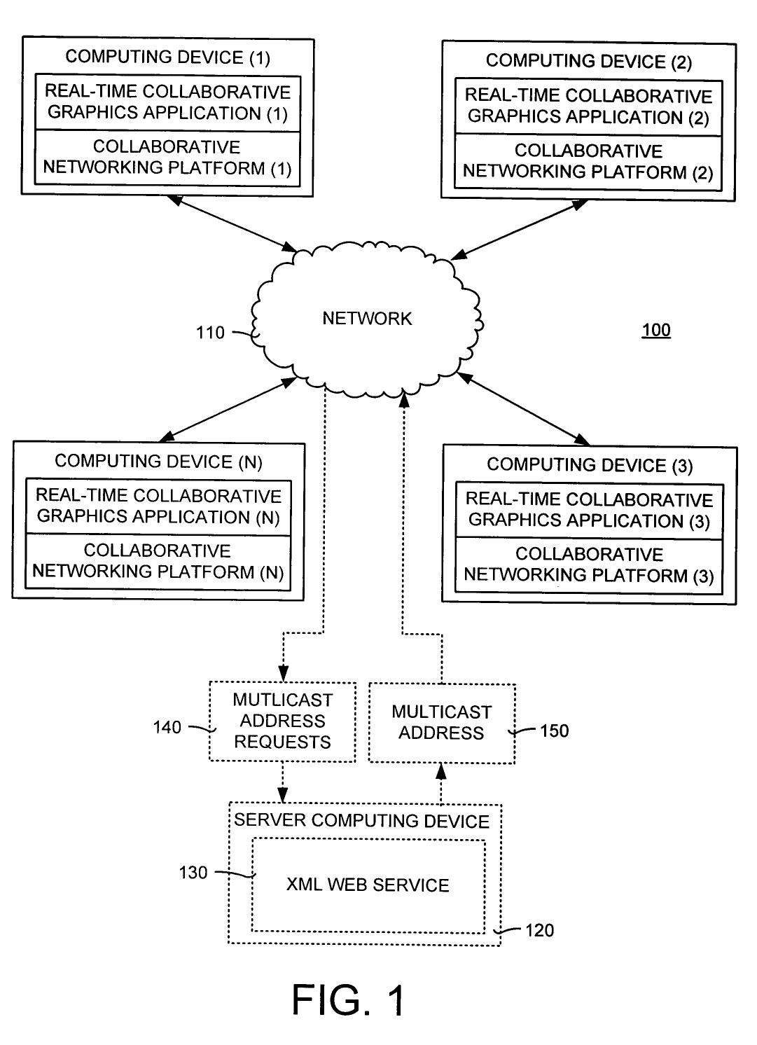

FIG. 1 is a block diagram illustrating an exemplary implementation of the real-time collaborative graphics application system, including the real-time collaborative graphics application and method disclosed herein. It should be noted that FIG. 1 is merely one of several ways in which the real-time collaborative graphics application and method may implemented and used.

The real-time collaborative graphics application system 100 includes a collaborative networking environment that uses a peer-to-peer computer network having a plurality of computing devices connected therein. As shown in FIG. 1, the real-time collaborative graphics application system 100 includes N number of computing devices, including a computing device (1), a computing device (2), a computing device (3), and so forth to a computing device (N). Each of these computing devices (1) to (N) is connected to a network 110. The network can be, for example, the Internet or an intranet, and the computing devices (1) to (N) may be connected to the network 110 by wireless, cable, Internet, or combinations of these.

Each of the computing devices contains a collaborative networking platform, shown in FIG. 1 as collaborative networking platforms (1) to (N). In a tested embodiment, the collaborative networking platform is ConferenceXP by Microsoft® Corporation. ConferenceXP is a research platform uses a peer-to-peer architecture instead of a client/server architecture. ConferenceXP is based on the NET Framework. In addition, ConferenceXP generally uses multicast, although unicast may be used where multicast is not available. ConferenceXP is installed on each machine, computing devices (1) to (N).

Running on top of the collaborative networking platforms (1) to (N) on each of the computing devices (1) to (N) is a real-time collaborative graphics application. The real-time collaborative graphics application is shown in FIG. 1 on each of the computing devices (1) to (N) as real-time collaborative graphics application (1) to (N). In a tested embodiment, the graphics application is Visio® by Microsoft® Corporation.

When a user at each of the computing devices (1) to (N) first joins the ConferenceXP user group (also known as a “venue” in ConferenceXP documentation), the user must obtain a multicast address. In order to obtain this multicast address a server computing device 120 is used for this one time. In other words, server computing device 120 is only used at startup to give out multicast addresses. The fact that the server computing device 120 is only used to provide multicast addresses is illustrated in FIG. 1 by the dashed lines. The server computing device 120 includes an XML Web Service 130 that holds all the IP multicast addresses (including venue name and icons). The participants obtain the IP multicast address when they join a venue. After that no server is required. More specifically, at startup, each of the computing devices (1) to (N) places request for a multicast address 140 to the server computing device 120. In response, the server computing device 120 answers with a multicast address 150 for that particular multicast group (or venue). The multicast address 150 tells other computing devices on the network where to find the particular computing device. Alternatively, there is a way to avoid using the XML Web Service 130. In particular, if participants agree ahead of time on venue having a specific IP multicast address, then the need for using the XML Web Service 130 is eliminated. In this situation, the venue is called a “local venue.”

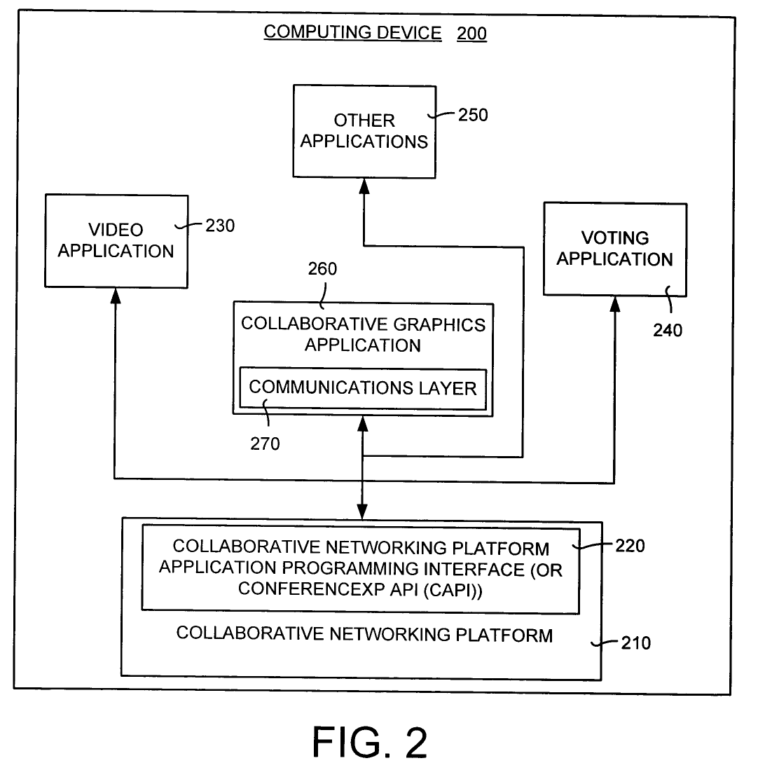

FIG. 2 is a detailed block diagram illustrating details of the real-time collaborative graphics application and method disclosed herein. A computing device 200 (such as the computing devices (1) to (N) shown in FIG. 1) has running on it a collaborative networking platform 210. The collaborative networking platform 210 includes a collaborative networking platform applications programming interface (also known in Conference API as ConferenceXP application programming interface (CAPI)) 220. The CAPI 220 is a set of tools for building software application on top of the collaborative networking platform 210. The CAPI 220 allows programmers to write applications consistent with the operating environment and to easily send and receive objects inside venues (multicast) without having to deal with the complexity of the networking layer implementation.

Many types of applications can be running on top of the collaborative networking platform 210. As shown in FIG. 2, these applications include a video application 230, for providing streaming video capability to the network, and a voting application 240, which allows users to use voting and discussion in their collaborative efforts. Other types of applications 250 also are possible.

The real-time collaborative graphics application 260 disclosed herein is designed to run on top of the collaborative network platform 210. The real-time collaborative graphics application 260 utilizes the full capabilities of the collaborative networking platform 210 to provide a rich array of collaborative features and real-time collaboration. A communications layer 270 of the collaborative graphics application 260 serves as an interface between the collaborative graphics application 260 and the collaborative networking platform 210. It should be noted that communications layers for each of the other applications (such as the video application 230, the voting application 240, and the other applications 250) have been omitted to avoid clutter.

III. Exemplary Operating Environment

The real-time collaborative graphics application and method are designed to operate in a computing environment and on a computing device. The computing environment in which the real-time collaborative graphics application and method operates will now be discussed. The following discussion is intended to provide a brief, general description of a suitable computing environment in which the real-time collaborative graphics application and method may be implemented.

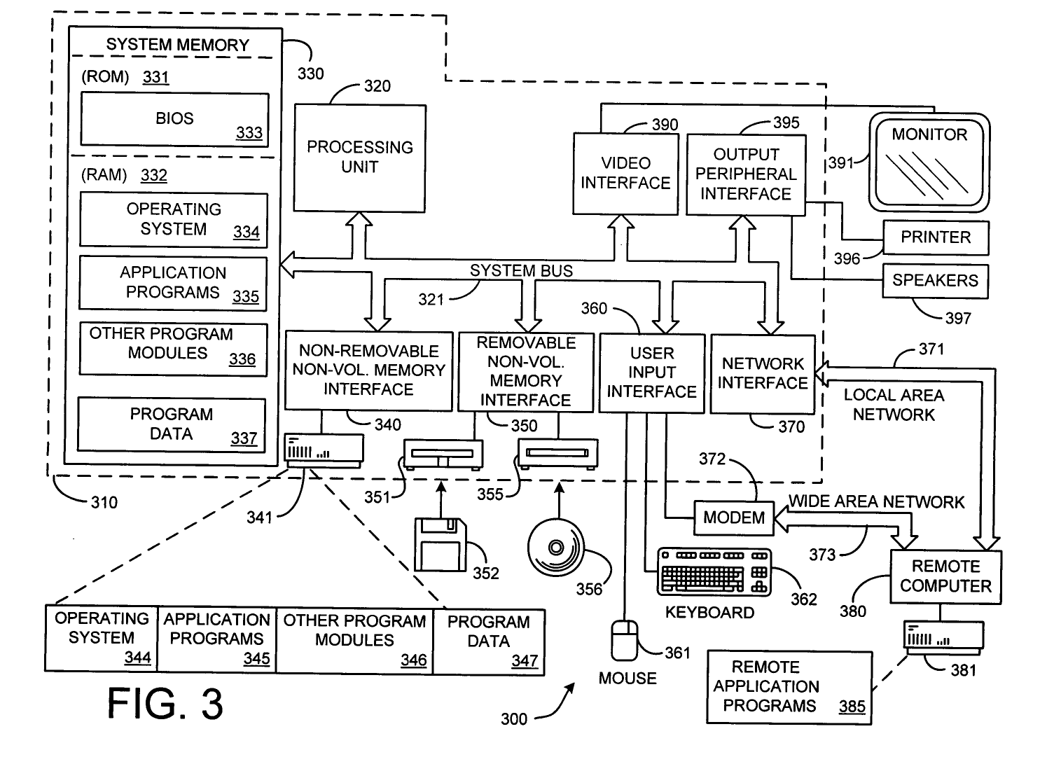

FIG. 3 illustrates an example of a suitable computing system environment in which the real-time collaborative graphics application and method shown in FIGS. 1 and 2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The real-time collaborative graphics application and method is operational with numerous other general purpose or special purpose computing system environments or configurations. Examples of well known computing systems, environments, and/or configurations that may be suitable for use with the real-time collaborative graphics application and method include, but are not limited to, personal computers, server computers, hand-held, laptop, Tablet PC or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The real-time collaborative graphics application and method may be described in the general context of computer-executable instructions, such as program modules, being executed by a computer. Generally, program modules include routines, programs, objects, components, data structures, etc., that perform particular tasks or implement particular abstract data types. The real-time collaborative graphics application and method may also be practiced in distributed computing environments where tasks are performed by remote processing devices that are linked through a communications network. In a distributed computing environment, program modules may be located in both local and remote computer storage media including memory storage devices. With reference to FIG. 3, an exemplary system for implementing the real-time collaborative graphics application and method includes a general-purpose computing device in the form of a computer 310, where the computing devices (1) to (N) and the server computing device 120 are specific examples of the computer 310.

Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer readable media. Computer readable media can be any available media that can be accessed by the computer 320 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 310. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within the computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 320 through a user input interface 360 that is coupled to the system bus 321, but may be connected by other interface and bus structures, such as, for example, a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. The network interface or adapter could be wired or wireless. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

IV. Operational Overview

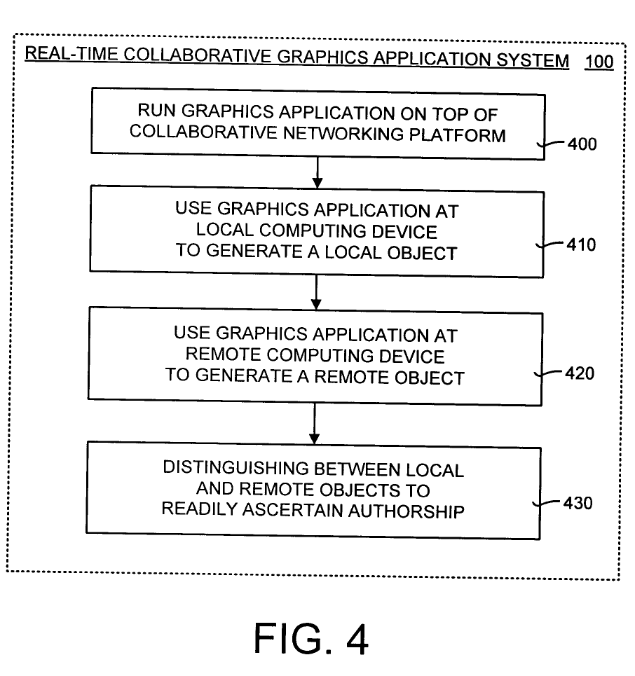

The operation of the real-time collaborative graphics application system 100 shown in FIG. 1 now will be discussed. FIG. 4 is a general flow diagram illustrating the general operation of the real-time collaborative graphics application system 100 shown in FIG. 1. The real-time collaborative graphics method begins by running a graphics application on top of a collaborative networking platform (box 400). In a test embodiment, the collaborative networking platform is ConferenceXP by Microsoft® Corporation. A graphics application is used at a local computing device to generate a local object (box 410). A local computing device is the computing device on the network used by a local user. In a tested embodiment, the graphics application is Visio® by Microsoft® Corporation.

The graphics application also is used by other users to generate objects. In particular, the graphics application is used at remote computing devices to generated remote objects (box 420). A identifier is used to distinguish between the local and remote objects such that authorship can be readily ascertained (box 430). In other words, an identifier (such as color, text, line thickness) is used so that anyone viewing the objects in the application can readily determine whether the object was generated by the local user or one of the remote users. It should be noted that the term “generation” means both the creation and manipulation of an object.

V. Operational Details and Working Example

In order to more fully understand the real-time collaborative graphics application and method shown in FIGS. 1, 3 and 4, the operational details of an exemplary working example are presented. It should be noted that this working example is only one way in which the real-time collaborative graphics application and method may be implemented.

In this working example, the collaborative networking platform is ConferenceXP and the graphics application is Visio®. The source code for Conference XP is publicly posted at www.conferencexp.com. ConferenceXP research platform allows different applications to be launched in every client. As an example, ConferenceXP uses a custom presentation tool (that could be on the professor or initiator side) that launches the OneNote application on the students or employees side. This kind of scenario could be imagined with a Visio® application by Microsoft® Corporation where the initiator has a different application with possibility to monitor all diagrams and to control that all the diagrams collaboratively created such that they make sense together. In addition, ConferenceXP includes a wireless support on multicast that allows recovery from group of network packet loss (which is typically the loss pattern on wireless network). This new support enable new type of collaboration with TabletPC (and could be extended to hand-held devices) that people could carry around while working.

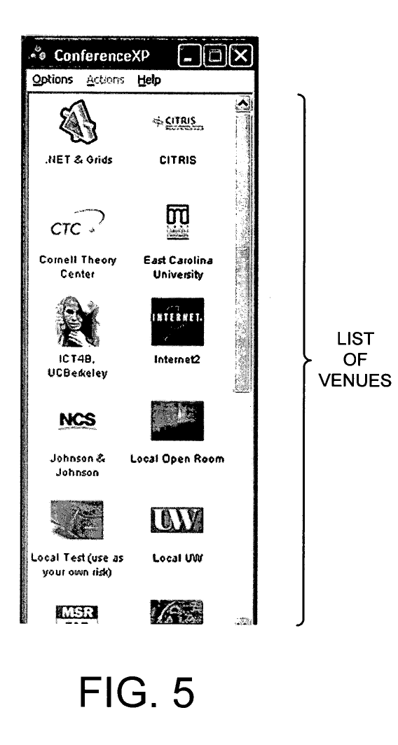

FIG. 5 illustrates an initialization process of a working example whereby a venue is joined. In particular, FIG. 5 shows how a user can join a ConferenceXP venue. When ConferenceXP is started, the user needs to select a venue from a list of venues, as shown in FIG. 5. By way of example, a venue can be a classroom or conference room where the use can collaborate with other users. A venue is given by an Internet Protocol (IP) multicast address. If a user decides to select a certain venue, then local computing device requests from a server the IP multicast address for that venue. Thus, during the initialization process a venue is selected and a server is accessed to obtain an IP multicast address for that venue. Next, the local computing device registers with the venue using the IP multicast address received.

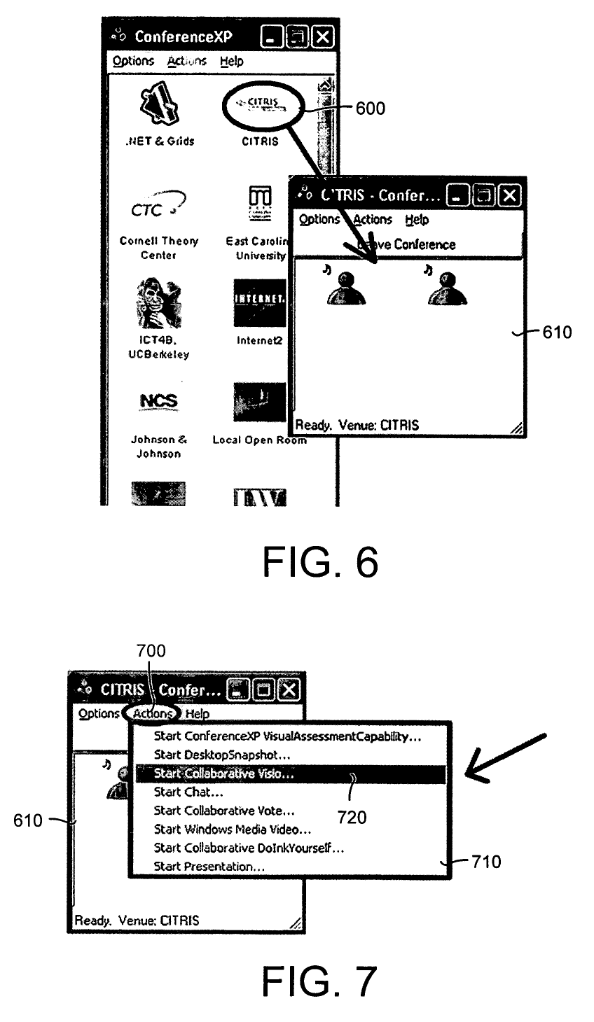

FIG. 6 illustrates what the local user sees after a venue is selected. In particular, once the user has joined a venue the other users (also known as “participants” in ConferenceXP documentation and code) on the venue can be seen. As shown in FIG. 6, the user has decided to join Citris venue 600. Once the user has joined, a conferencing window 610 is opened that shows to the user who else is in the Citris venue 600. In this working example, there are two other users in the Citris venue 600.

FIG. 7 illustrates a user selecting to start the Collaborative Visio application. In particular, the user selects the “Actions” label 700 inside the conferencing window 610 and a drop-down menu appears 710. From this drop-down menu 710, the user selects on “Start Collaborative Visio” 720 in order to launch the collaborative Visio® application.

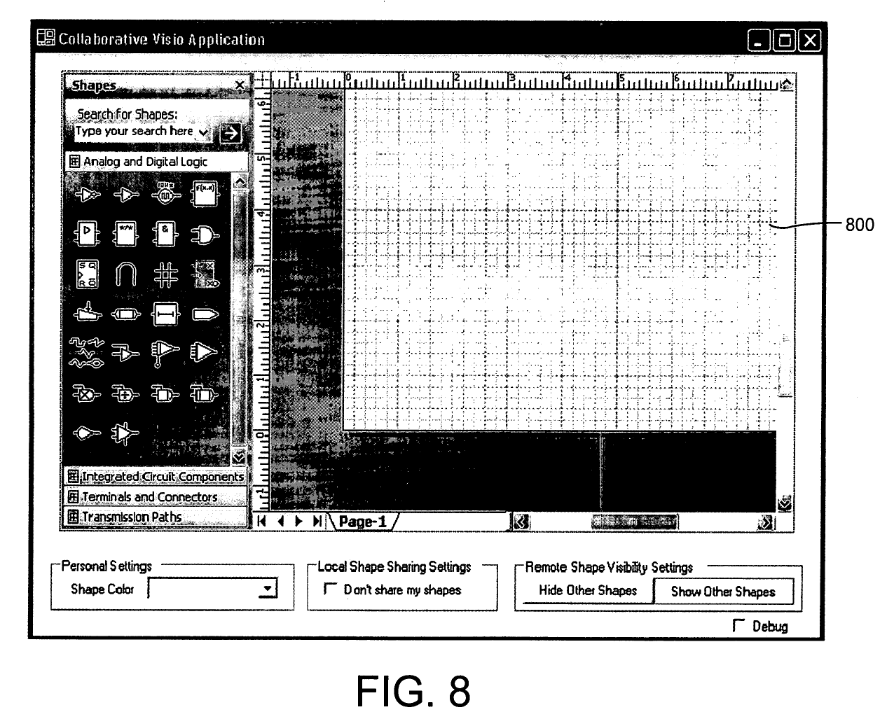

The local user who just launched the application sees a local document 800, such as the one shown in FIG. 8. As soon as the Visio® application is launched on the local computing device the application is automatically launched on all remote computing devices that are on the same venue. The remote users are able to see their own version of the local document 800. It should be noted that ConferenceXP can launch several applications simultaneously, such that Visio® and other applications such as a voting application and a video application can run at the same time. In the working example, a Visio® ActiveX control was used to create the application and code was written to allow access to the Conference XP API from the Visio® ActiveX control. The application user interface is a Windows® form that embeds the Visio® ActiveX control and some Windows® controls in the window. ActiveX is a control that has full access to the ConferenceXP platform and sets forth rules on how applications should share information. An ActiveX control allows a user to create a Visio® object anywhere inside any ConferenceXP application. The ActiveX control is installed on each machine.

Every user can select an identifier for himself. This identifier is used to distinguish each user from every other user. In this manner, the authorship of a object, modification or both in the application can be readily ascertained by all users on the venue. By way of example, the identifier can be color, text (such as labels stating the user's name) and line thickness). In this working example, color was used as the identifier. In this working example, there is no restriction on color, so that 2 participants could use the same color if they desired. This may be desirable if the two participants want to be viewed as part of a group. Alternatively, however, each color could be unique to a certain participant. One thing that is always unique with Conference XP is that every participant has a CNAME (Canonical Name). This CNAME usually is an e-mail address (such as someone@microsoft.com). The CNAME has to be unique within a venue. This prevents two participants with the same CNAME from entering the same venue. Thus, every participant has a CNAME, which is a unique identifier within a venue. In addition, every Visio® shape has a unique identifier, so that behind the scenes it is known how to map every local shape to the corresponding remote shape. Moreover, the identifier (which in this working example is color) of a shape is used to recognize the shape owner (or author), but in this working example there is no requirement that the identifier be unique.

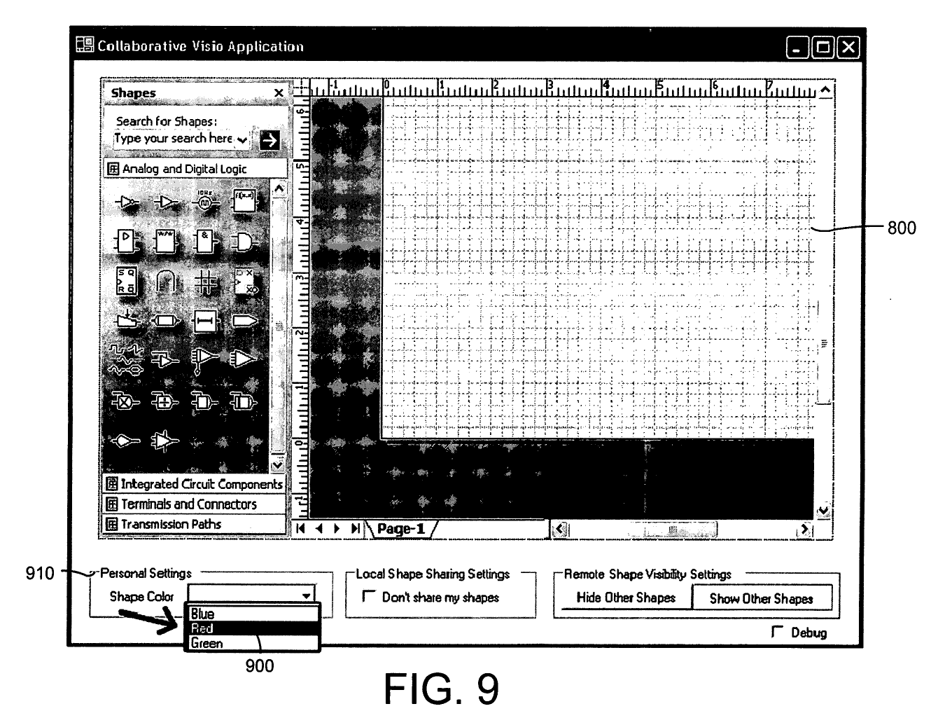

FIG. 9 illustrates the application window as the local user selects a color for his shapes or objects. In this working example, the local user has selected the color “red” 900 from the “Personal Settings” label 910. Alternatively, other types of identifiers could be listed under the “Personal Settings” label 910. Moreover, the name of the object owner and author can be seen when any user in the venue rolls over the object. In this working example, the CNAME of the owner is not displayed. However, in an alternate embodiment, when a user roll over a Visio® shape the CNAME could be displayed next to each shape based on a user's configuration settings.

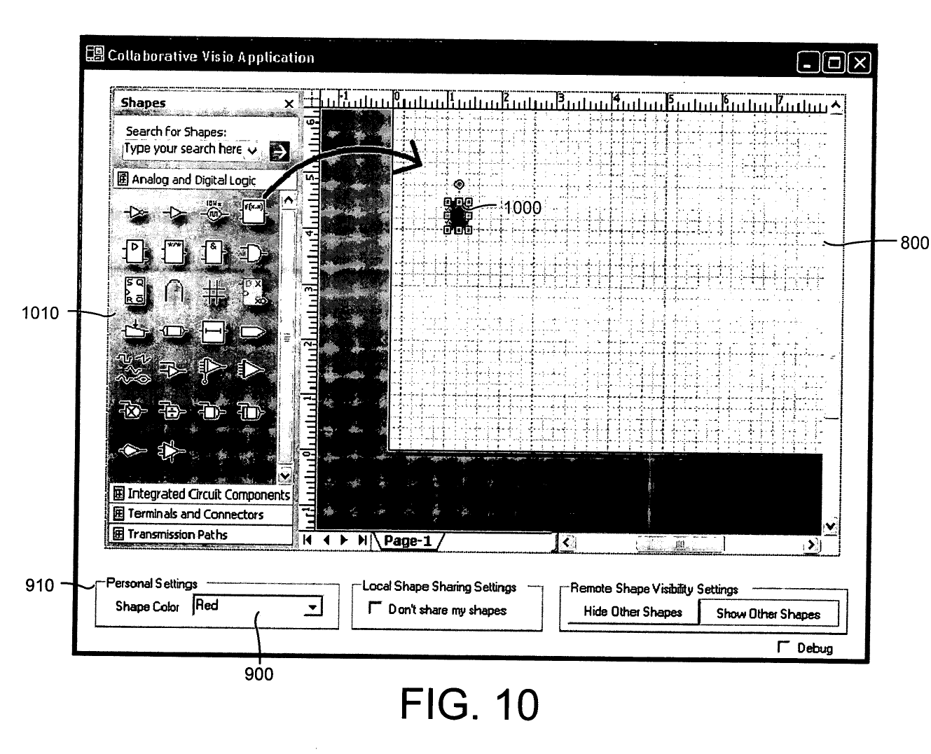

FIG. 10 illustrates what happens when a local user drags and drops a first local object 1000 onto the local document 800. In FIG. 10, the local user takes his pointing device (such as a mouse) and drags and drops the first local object 1000 from the objects area 1010 to the local document 800. The first local object 1000 will automatically appear on all computing devices of the remote users in the same venue. In this case, since the local user selected as his identifier the color red, the first local object 1000 will appear to the local and remote users in red.

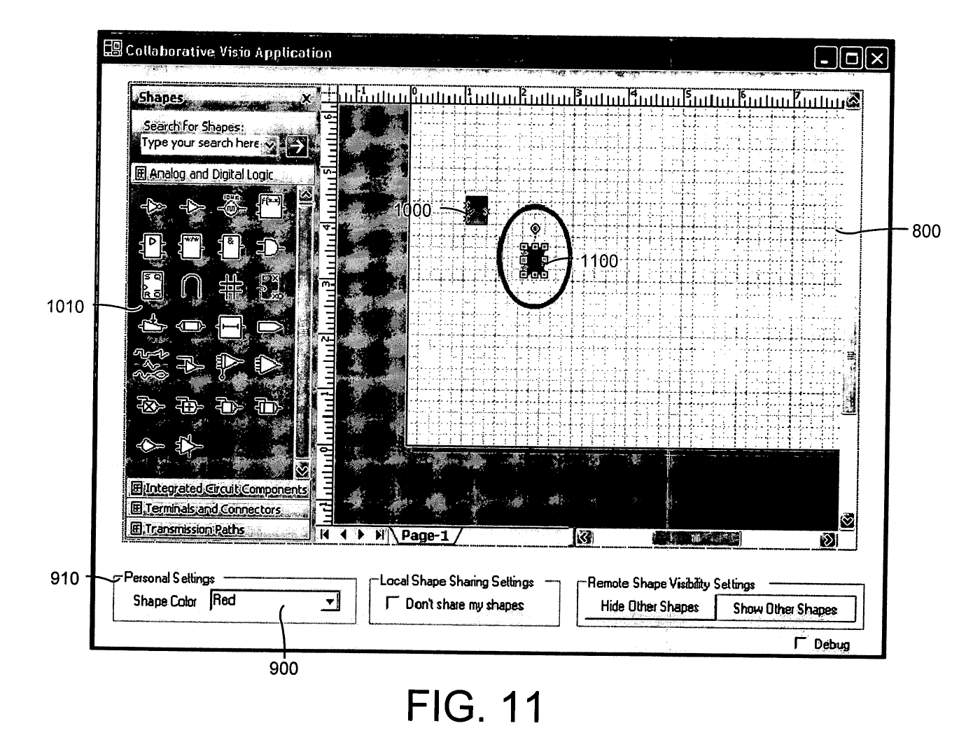

FIG. 11 illustrates what a local user sees when a remote user adds a object. In particular, assume that a particular remote user has selected as his identifier the color blue. If the remote user adds a remote object 1100, the remote object 1100 will appear to each user within the venue. From the local user's perspective, the remote object 1100 will appear in real time in the local document 800. The remote object 1100 will be seen in the color blue, since this is the identifier selected by the particular remote user.

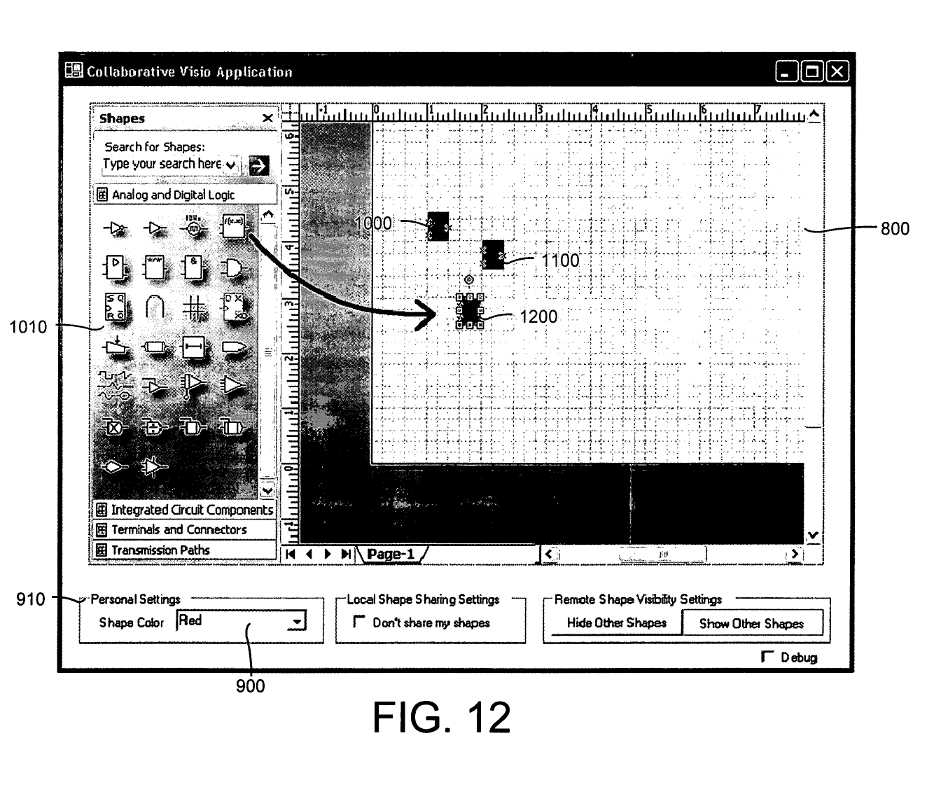

FIG. 12 illustrates the local user adding another object to the local document 800. The local user drags and drops a second local object 1200 from the objects area 1010 onto the local document 800. The second local object 1200 then automatically appears on all the computing devices of the remote users in the same venue. The second local object 1200 appears in the Visio® applications of the remote users. The second local object 1200 appears in red, which is the identifier selected by the local user.

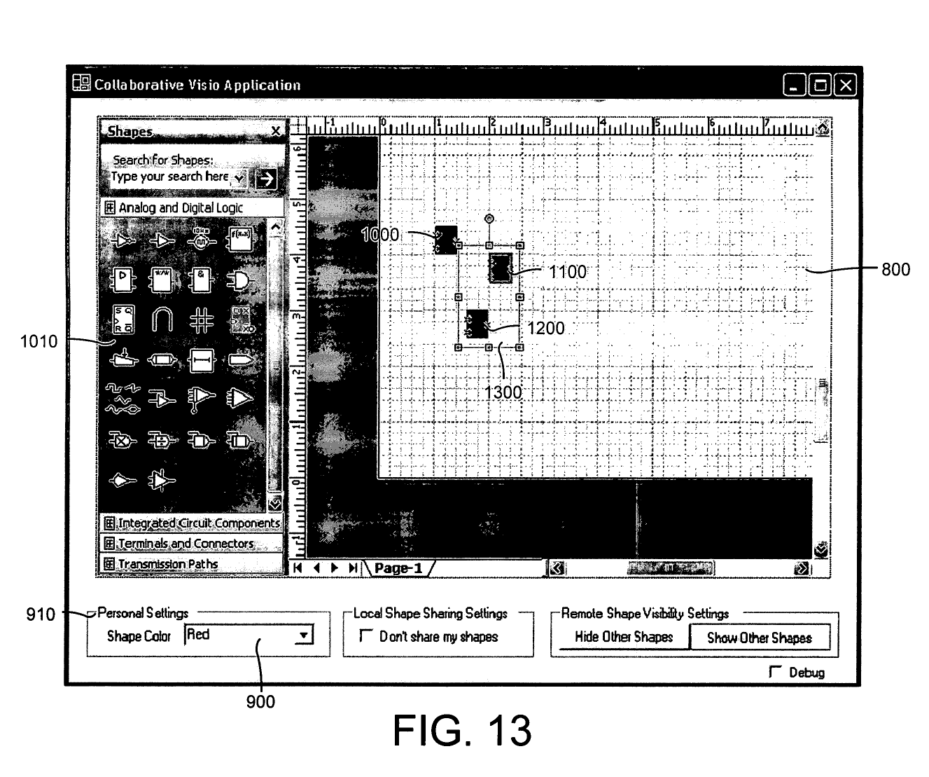

FIG. 13 illustrates the local user selected a combination of local and remote objects. The local user can use a input or pointing device (such as a mouse) to select any object or group of objects. This includes a mixed group of objects, such as local and remote objects. As shown in FIG. 13, the local user has selected the remote object 1100 and the second local object 1200 to make up a combination 1300 of local and remote objects. This combination 1300 of local and remote objects can be move and manipulated by the local user. Any movement and manipulation by the local user will be reflected in the Visio® applications of all remote users in the same venue.

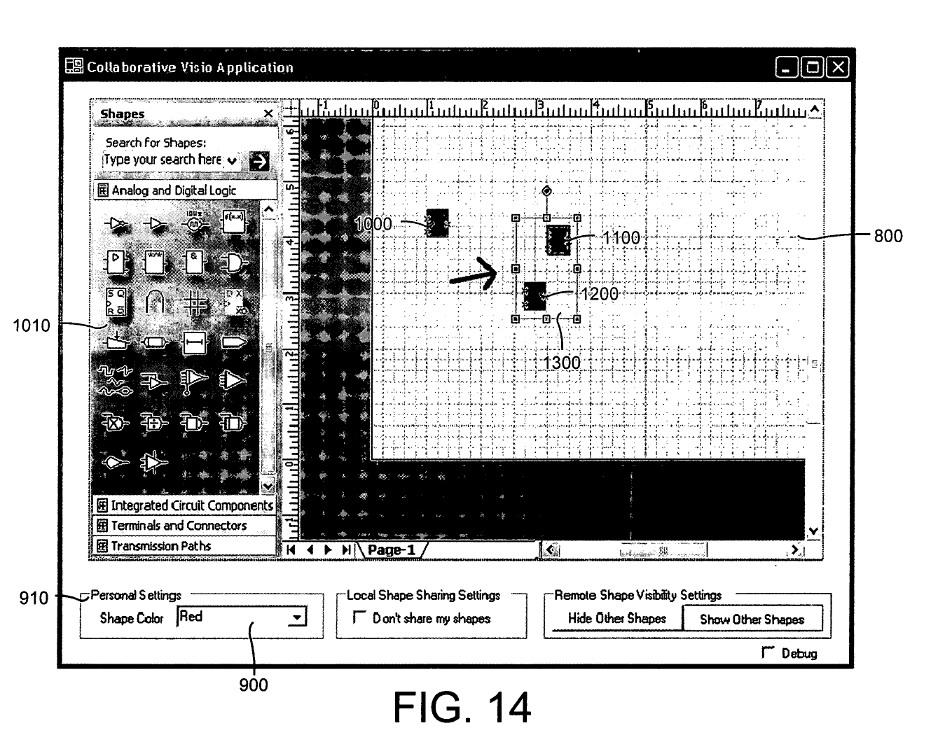

Any of the users in the venue, both local and remote users, can select any combination of local and remote objects. For example, FIG. 14 illustrates the local user moving the combination 1300 of remote object 1100 and the second local object 1200 from the location shown in FIG. 13 to another location within the local document 800. The selected combination 1300 of local and remote objects will be moved on the Visio® applications of the local user and all the remote users in the venue. Thus, each user in the venue has the capability to select and manipulate a combination of local and remote objects simultaneously.

The movement of the combination 1300 (or any of the local or remote objects) is displayed to the remote users in the venue in one of two ways. First, the movement and manipulation of local objects, remote objects, or a combination thereof, can be displayed in real time, as it is occurring. Alternatively, the movement and manipulation of local objects, remote objects, or a combination thereof, can be displayed to the remote users in the venue after the local user has released the button of a pointing device (such as a mouse).

The ability to hide objects also is an important feature of the real-time collaborative graphics application and method. Any user in the venue is able to hide any remote objects and decide not to share his local objects with remote users. In addition, remote objects can be hidden by a participant's CNAME. This would allow hiding of just remote objects belonging to particular participants. Being able to hide remote objects or keep local objects from being seen by remote users is a key feature that differentiates the real-time collaborative graphics application and method from application sharing.

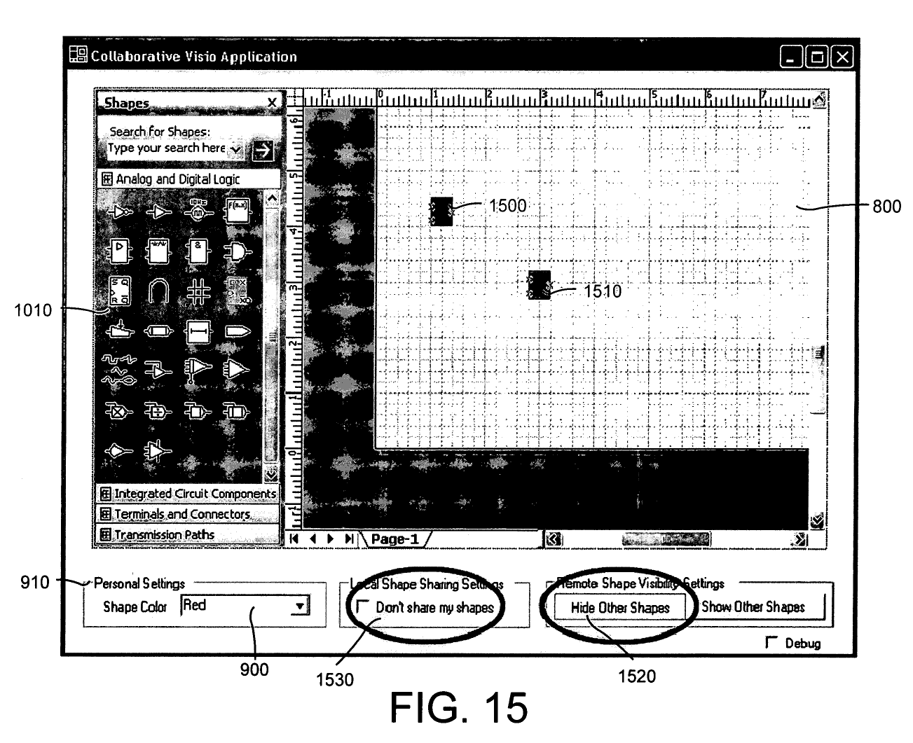

FIG. 15 illustrates how a local user can choose to hide remote objects, choose not to share local objects, or both. Specifically, as shown in FIG. 15, the local user has selected a third local object 1500 and a fourth local object 1510. There are no remote objects being shown, because the local user has decided to hide the remote objects. This achieved by checking the box entitled “Hide Other Shapes” 1520, as shown in FIG. 15 by the circled area. Moreover, the local user can also choose not to share his objects with the remote users in the venue. This is achieved by checking the box entitled “Don't share my shapes” 1530, as shown in FIG. 15 by another circled area. Moreover, the local user can select from a list of participant's CNAMEs such that those participants selected would still receive the local objects even after the local user decided to hide them.

The feature of hiding remote objects and not sharing local objects with remote users can be extended to hiding shapes of a specific user or sub-group. Sub-groups are discussed in detail below. The ability not to share hidden objects is very important for collaboration. By way of example, suppose that the local user wants to create a Visio® diagram (or sub part of a diagram) and wait until the diagram is finished before letting others in the venue see the diagram. In addition, a local user could choose to not share a local object with a specific user or sub-group. In addition, another feature is that the local user can choose to not share a subset of his local objects. For example, the local user may choose not to share a selected local objects, but all the other local objects are shared.

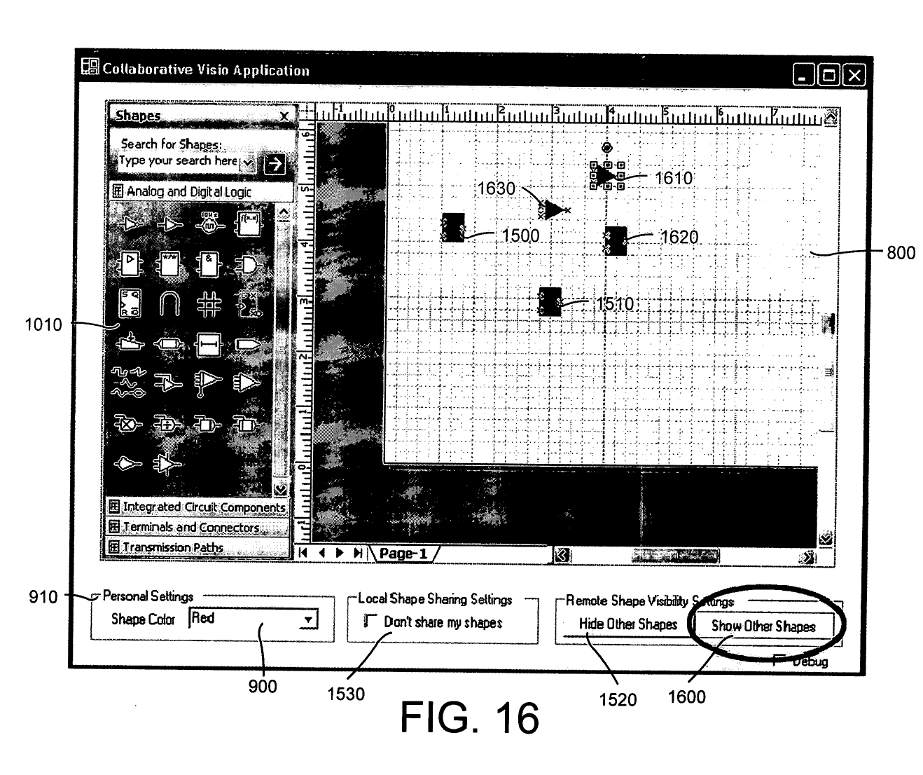

FIG. 16 illustrates the local user choosing to view the hidden remote objects. As shown in FIG. 16, if the local user wants to view the hidden objects again, the local user can check the “Show Other Shapes” box 1600. The local document 800 then will automatically update with all changes made to the document since the “Hide Other Shapes” box 1520 was selected. As shown in FIG. 16, the changes have been updated. In particular, the third local object 1500 and the fourth local object 1510 remain the same, but a second remote object 1610, a third remote object 1620 and a fourth remote object 1630 have been added. Moreover, as shown in FIG. 16, the local user has selected the second remote object 1610.

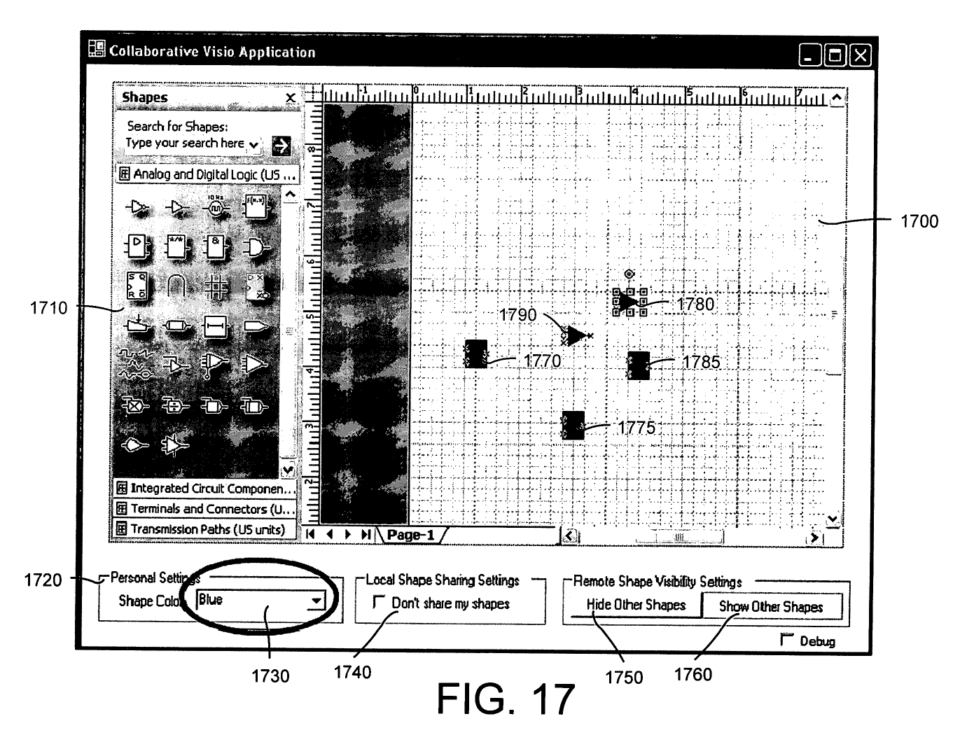

FIG. 17 illustrates from a remote user's perspective the updated changes shown in FIG. 16. A remote document 1700 is displayed to a remote user on a remote computing device. The remote document 1700 has basically the same user interface, including a shapes area 1710, a “Personal Settings” label 1720, and a color selection for the identifier. In this case, the remote user has selected blue 1730 as his identifier. The remote document 1700 also includes a “Don't share my shapes” box 1740, a “Hide Other Shapes” box 1750, and a “Show Other Shapes” box 1760. From the perspective of the remote user, a fourth remote object 1770, fifth remote object 1775, fifth local object 1780, sixth local object 1785, and a seventh local object 1790 in the remote document 1700 correspond to the third local object 1500, fourth local object 1510, second remote object 1610, third remote object 1620, fourth remote object 1630 of the local document 800, respectively. Moreover, as shown in FIG. 17, a user has selected the fifth local object 1780. The benefit of automatic updating is that the remote user could be looking at another part of the diagram in the remote document 1700 or be on another page and still receive all of the updates.

The real-time collaborative graphics application and method also includes a constraints solver that applies constraints to the local document 800 and remote document 1700. The local and remote users are notified if a constraint associated with a local or remote object is violated. Constraints minimize the amount of communication needed to collaborate between users and make the collaboration process more natural for users. Several different types of constraints are possible, including constraints within the same drawing page, and constraints between drawing pages on the same project.

By way of example, suppose that users are collaborating on the design of a car, and a local user is designing the outside of the car and a remote user is designing the engine. A constraint may exist whereby the engine must fit into the engine compartment of the car. If the local user designs the car such that the engine compartment is smaller than the engine, then the constraint solver of the real-time collaborative graphics application and method notifies local user in real time of this constraint violation. As another example, if a local user is creating a software architecture diagram, the local user could be informed in real time if an object that the local user is using has been deleted by a remote user.

Because the real-time collaborative graphics application and method runs on top of a collaborative networking platform, real-time collaboration can be achieved. Moreover, the platform can run a plurality of applications simultaneously. Taking advantage of this fact, the real-time collaborative graphics application and method includes a discussion thread that allows local and remote users on a venue to discuss a particular collaboration topic. This discussion thread can include video (including video conferencing), photographs, shared whiteboards, and text. In addition, the discussion thread allows the local and remote users to vote on a particular collaboration topic. For example, the local user may ask for a vote from the remote users as to where an object should be moved.

The real-time collaborative graphics application and method also includes using sub-groups. Sub-groups can be formed from users on the venue such that each user within the sub-group can collaborate with each other. In addition, each user in the sub-group has all the features of the real-time collaborative graphics application and method described above available to them. Sub-grouping allows users to collaborate on a diagram that is part of larger diagram. This allows collaboration between a large number of users that are divided into sub-groups.

In a teaching environment (such as a school or university), sub-grouping allows sub-groups of students to collaborate and create a subset of a diagram while a professor keeps track of the progress of each sub-group in real time. At the end of the exercise, the professor is able to go through each of the sub-diagrams and use a computing device (such as a Tablet PC) to mark-up the sub-diagrams and add notes and comments. In addition, the professor can see and annotate or interact in real time what is occurring on each student's computer and with whom each student is currently interacting.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for collaborating on manipulation of objects using a computer network having a local computing device and a remote computing device, comprising:
running a graphics application on the computer network on top of a collaborative networking platform such that the graphics application is displayed on the local computing device and the remote computing device;
using the graphics application at the local computing device to cause a local user to manipulate the objects to generate local objects;
using the graphics application at the remote computing device to cause a remote user to manipulate the objects to generate remote objects; and
distinguishing between the local objects and the remote objects such that authorship of the local and remote objects can be readily ascertained to identify that the local user manipulated the local objects and the remote user manipulated the remote objects.

2. The method as set forth in claim 1, further comprising using an identifier to identify the authorship of the local and the remote objects.

3. The method as set forth in claim 2, wherein the identifier is at least one of: (a) color; (b) labels.

4. The method as set forth in claim 1, wherein the graphics application is a Visio® application.

5. The method as set forth in claim 1, further comprising allowing the local user to hide the local objects such that the local objects cannot be seen by the remote user at the remote computing device.

6. The method as set forth in claim 5, further comprising hiding the local objects for at least one of: (a) the local user; (b) a group of users; (c) a sub-group of users.

7. The method as set forth in claim 1, further comprising allowing the local user to hide the remote objects such that the remote objects cannot be seen by the local user at the local computing device.

8. The method as set forth in claim 1, further comprising:
hiding at least one of the local and remote objects such that the hidden object can only be seen by its author;
deciding to view the hidden object; and
automatically updating changes made to the hidden object.

9. The method as set forth in claim 8, further comprising automatically updating changes made to the hidden object starting from a time when the hidden object was hidden.

10. The method as set forth in claim 1, further comprising allowing the local user and the remote user to select, independent of each other, objects displayed on the local and remote computing devices.

11. The method as set forth in claim 10, wherein the objects further comprise at least one of: (a) the local object; and (b) the remote object.

12. The method as set forth in claim 1, further comprising:
having a local user select the local object and the remote object; and
manipulating the local and remote objects together using the local computing device.

13. The method as set forth in claim 12, wherein the manipulating further comprises at least one of: (a) moving the local and remote objects; (b) resizing the local and remote objects; (c) grouping the local and remote objects.

14. The method as set forth in claim 12, further comprising displaying results of the manipulating of the local and remote objects in real time on the local computing device.

15. The method as set forth in claim 12, further comprising displaying results of the manipulating of the local and remote objects when a button of a pointing device at the local computing device is released.

16. The method as set forth in claim 1, further comprising defining a sub-group of users on the computer network that can collaborate with each other within the sub-group.

17. The method as set forth in claim 16, further comprising applying constraints to objects manipulated by the users within the sub-group.

18. The method as set forth in claim 16, further comprising allowing at least one of the users in the sub-group to hide objects.

19. The method as set forth in claim 1, further comprising creating a discussion thread on the computer network between the local and remote users for the purpose of discussing the manipulation of objects within the collaborative graphics application.

20. The method as set forth in claim 19, wherein the discussion thread includes at least one of: (a) text; (b) photographs; (c) video; (d) shared whiteboard.

21. The method as set forth in claim 19, further comprising using constraint solving to notify the local and remote users if a constraint associated with the local and remote objects has been violated.

22. A computer-readable medium having computer-executable instructions for performing the method recited in claim 1.

23. A computer-implemented method for collaborating on creation and manipulation of graphical objects, the collaboration occurring between at least two users over a computer network having a collaborative networking platform, comprising:
providing each user with a graphics application running over the collaborative networking platform;
having the users create and manipulate graphical objects using the graphics application;
associating an identifier to each object created and manipulated by any of the users such that a user who generated and manipulated a particular one of the graphical objects can be readily identified; and
allowing the users to select a mixed group of objects containing objects created and manipulated a particular user and by any of the other users.

24. The computer-implemented method of claim 23, further comprising choosing to hide from other users graphical objects created and manipulated by a particular user.

25. The computer-implemented method of claim 23, further comprising hiding from a view of a user graphical objects created and manipulated by other users.

26. The computer-implemented method of claim 23, wherein the identifier further comprises at least one of the following associated with a user that created and manipulated a particular graphical object: (a) color; (b) name of the user that created and manipulated the particular graphical object; (c) line thickness of the particular graphical object.

27. The computer-implemented method of claim 23, further comprising using constraint solving to apply constraints to graphical objects created by the users.

28. A computer-readable medium having computer-executable instructions for performing the computer-implemented method recited in claim 23.

29. A method for collaborating in real time with other users over a computer network in the creation and manipulation of graphical objects, comprising:
running a collaborative networking platform on the computer network;
running a graphics application over the collaborative networking system;
having a local user, using a local computer on the computer network, produce and manipulate a local graphical object using the graphics application;
having remote users, using remote computers on the computer network, produce and manipulate remote graphical objects using the graphics application;
distinguishing between the local graphical object authored by the local user and each of the remote objects authored by each of the remote users so that each user on the computer network can ascertain the authorship of each graphical object;
allowing the local and remote users to select and manipulate both the local and remote graphical objects;
allowing the local user to hide the local graphical object from viewing by the remote users; and
allowing the remote users to hide their respective remote graphical objects from viewing by the local user and other remote users.

30. The method of claim 29, wherein the collaborative networking platform is ConferenceXP by Microsoft® Corporation.

31. The method of claim 30, wherein the graphics application is Visio® by Microsoft® Corporation.

32. The method of claim 31, further comprising allowing the local user to hide any graphical objects created and manipulated by the remote users such that the hidden graphical objects cannot be viewed by the local user.

33. The method of claim 32, further comprising:
having the local user unhide the graphical objects created and manipulated by the remote users such that the local user can once again view the unhidden graphical objects; and
updating the unhidden graphical objects automatically such that all changes made to the unhidden graphical objects since they were hidden may be viewed.

34. The method of claim 31, further comprising defining a collaborative sub-group among the users such that members of the sub-group may collaborate in real time among themselves.

35. The method of claim 34, further comprising:
having the local user, who is a member of the sub-group, select both graphical objects created by the local user and graphical objects created by other members of the sub-group; and
having the local user manipulate in real time the selected graphical objects.

36. A real-time collaborative graphics application system for collaboration in the creation and manipulation of graphical objects, comprising:
a computer network having a plurality of computing devices connected therein including a local computing device for use by a local user and remote computing devices for use by remote users;
a collaborative networking platform running on each computing device of the computer network such that a real-time collaborative graphics application runs on top of the collaborative networking platform;
a local graphical object created by the local user on the local computing device using the real-time collaborative graphics application;
remote graphical objects created by the remote user using the real-time collaborative graphics application; and
identifiers associated with the local user and the remote users that are displayed on the local and remote computing devices to readily distinguish which of the users has created and manipulated each of the graphical objects.

37. The real-time collaborative graphics application system as set forth in claim 36, further comprising a remote object concealer that allows the local user to hide from view graphical objects created by the remote users.

38. The real-time collaborative graphics application system as set forth in claim 37, further comprising a local object concealer that allows the local user to hide graphical objects created by the local user from view of the remote users.

39. The real-time collaborative graphics application system as set forth in claim 36, further comprising an object manipulator that allows the local user to select a combination of local and remote graphical objects and manipulate those objects together in real time.

40. The real-time collaborative graphics application system as set forth in claim 36, further comprising an sub-group module that creates sub-groups of users from the local and remote users such that within each sub-group real-time collaboration on the creation and manipulation of graphical objects can occur.
